(19) United States
(12) Patent Application Publication
(10) Pub. No.: US 2008/0275689 A1
(43) Pub. Date: Nov. 6, 2008

(54) Method for Simulating a Circuit in the Steady State

(76) Inventor: Alexandre Bracale, Montrouge (FR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/547,547

(22) PCT Filed: Mar. 25, 2005
(86) PCT No.: PCT/IB2005/001016

§ 371 Date: Sep. 28, 2006

(30) Foreign Application Priority Data
Mar. 29, 2004 (FR) 0403201

(51) Int. Cl. G06F 17/50

(52) U.S. Cl. 703/14

(57) ABSTRACT

Method for simulating a response of an electronic circuit containing SOI transistors (220) and being in a steady state, characterised by the following steps: —creating of a list of transistors (220); memorising of the signals at the nodes (200, 201, 202) of each transistor (220) in the list, when inputs (201) of said circuit are excited during an established time; for each transistor (220), independently from the others, analysing a variation of a common electric property when we apply to, at their nodes (200, 201, 202), said corresponding memorised signals, in relation with a pre-set criterion of this variation; if the criterion is not respected modify once an initial electric environment of each transistor and return to the preceding step; excite the circuit, containing said transistors (220) with the new electric environment, during said time and check at each said transistor that said criterion is met.

The invention relates to the simulation of electronic component circuits.

More precisely the invention proposes a method for simulating a response of an electronic circuit when it has reached a steady state, said circuit comprising components such as SOI type transistors.

It is known that the simulation of such transistors poses new problems compared to that of transistors on solid substrate.

For example, in a CMOS (“Complementary Metal Oxide Semiconductor”) circuit on solid substrate, the potential of each node at a given instant is independent to the preceding operating instants.

This is not the case when said circuit comprises partially depleted SOI transistors.

We know that these transistors are composed of an internal zone, commonly named floating substrate or floating body, whose potential is floating and whose value influences the performance of said transistor, therefore the potential of the nodes of said circuit and its performance.

This floating potential is not directly established by the polarisations at the terminals of said transistor, but it depends on them.

Furthermore, it evolves towards a value established by the polarisation conditions with a certain amount of inertia due to the physical phenomena present in this floating zone (capacitive coupling, electron-hole recombination, etc.).

In the event that said potentials at the terminals of said transistor vary periodically, the variation of the potential of its floating substrate only becomes, itself, periodic after a certain number of periods corresponding to a state of the transistor known as steady state.

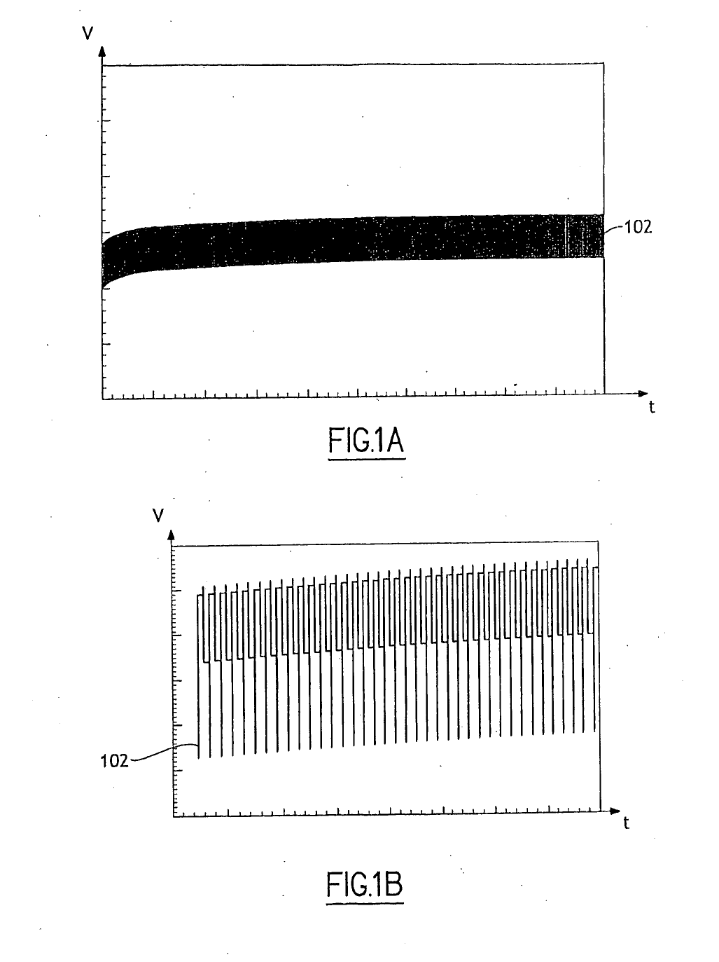

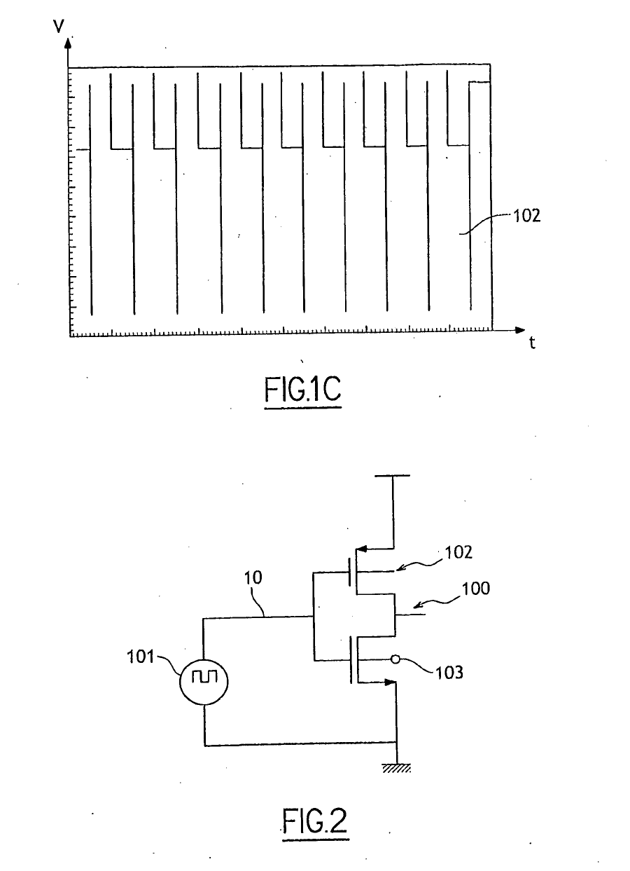

By way of example, FIGS. 1A to 1C illustrate a variation through time of the floating substrate of a P-type partially depleted SOI transistor, this transistor being connected to another transistor of type N so as to create a SOI inverter 100 (see FIG. 2).

A first signal 10 with a frequency of 100 MHz is applied at the input of said inverter via a source of periodic voltage 101 (FIG. 2).

We can notice on FIG. 1A the evolution of the potential of the floating substrate 102 of transistor P over a large time scale.

FIGS. 1B and 1C each represent a more detailed view of the signal at an instant respectively close to the start and end of the simulation.

At the start of simulation the transistor is not in a steady state.

FIG. 1B shows that said potential of substrate is periodic and in accordance with FIG. 1A, its mean value increases regularly.

As time passes, the transistor gets closer to the steady state and said potential stops increasing (see FIG. 1C).

It has reached an equilibrium value which corresponds to the steady state of the transistor.

We can now understand that the simulation of a circuit in the steady state is necessary as the potentials at its internal nodes and its performance will vary as long as said steady state has not been reached for each transistor.

However, as can be noticed, an inconvenience resides in that the simulated time of the circuit can be long as beforehand there must be sufficient time to reach said steady state and to then start the desired analysis.

Yet, the time allocated to said simulation, namely the time required for simulation equipment (a computer and a simulation software for example) to provide a simulation result, is notably dependent on the simulated time.

The design process of the circuit is therefore inevitably slowed down.

We also know of other factors that detrimentally affect the time allocated to a simulation, thus the design process.

A first factor relates to the number of transistors in the circuit which, as it increases, makes the latter relatively complex and lengthy to simulate.

A second factor is the presence of the supplementary node, the floating substrate, in a partially depleted SOI transistor.

Indeed, a specific calculation must be implemented in order to establish the potential of this node, which slows down each calculation step of a simulation.

We notice that, in what follows, a simulation duration will designate an allocated time for a simulation.

An overall solution known to overcome the above mentioned inconveniences consists in accelerating the establishing of the steady state of a circuit using the principle of charge conservation of the floating substrate of the partially depleted SOI transistors.

Indeed, we know that during a cycle, in the steady state, the variation of the charge QB of the floating substrate of such a transistor is nil.

This remark also stands for the variation of the potential Vb of the floating substrate.

Thus, in the steady state and notably during a cycle, the following known equation is verified:

ΔQb=ΔVb=0 (1)

Therefore there is, at the start of a cycle, a single value for the potential Vb and the charge Qb corresponding to the steady state.

This pair of values, which will be indicated Vb_{steady} and Qb_{steady} in the following text, corresponds to a variation in potential and in charge nil on all the following cycles.

The methods for establishing the steady state are based on the use of temporal electric simulations.

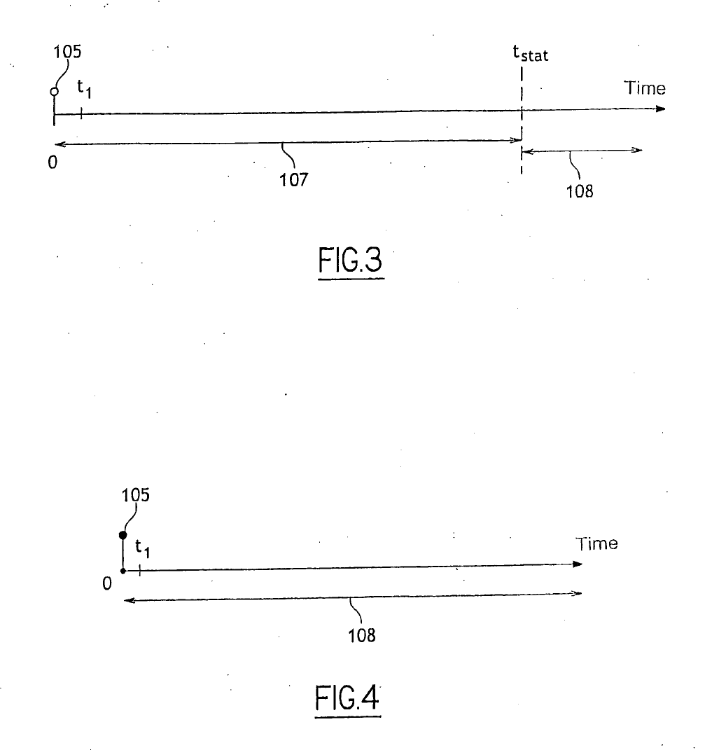

Such simulations consist in the following succession of steps, illustrated in FIG. 3.

A first static simulation 105 allows for the calculation of an initial point of polarisation.

A temporal simulation 106 then starts by using as the initial point of polarisation the one previously established.

This simulation is often broken down into two distinct stages.

A first stage identified as the transient stage 107 corresponds to the transient states of the circuit before reaching the steady state.

In this stage, the electric properties of the circuit evolve and lean towards an equilibrium.

A second stage called “steady stage” 108 corresponds to the simulation of said circuit in the steady state on one or several cycles.

We notice that, according to specific conditions, a temporal simulation 106 could only comprise said transient stage 107.

We will see that such a specificity is advantageously used in order to study a circuit in the transient stage 107 solely without simulating the stage in the steady state 108.

As regards the partially depleted SOI transistors, it is possible to fix their potential of floating substrate in the simulation 105 so that the latter are imposed during this analysis and then constitute, during the transient stage 107 of the temporal simulation 106, the initial floating value of said substrate.

In what follows, this initial value will be indicated by Vbᵢₙᵢₜ, and Vbᵢₙᵢₜ_{_{—}}_{steady} will correspond to the value Vbᵢₙᵢₜ when it has reached the value Vb_{steady}.

In other words, Vbᵢₙᵢₜ_{_{—}}_{steady} is said unique value of the potential of floating substrate in the steady state.

Said acceleration of the establishing of the steady state thus lies on two distinct goals.

A first goal consists in getting potential Vbᵢₙᵢₜ_{_{—}}_{steady} for a simulation duration as short as possible.

A second goal consists in limiting as much as possible the simulation time t_{steady}, t_{steady} being the time required to reach the steady state (see FIG. 3).

In order to attain these goals, a known method consists in implementing the following steps:
initialise Vbᵢₙᵢₜ;
carry out a simulation 106 on a cycle, corresponding to the duration between the times 0 and t1 in FIG. 3 (the length of the cycle is less than that of the transient stage 107);
determine if Vbᵢₙᵢₜ corresponds to Vbᵢₙᵢₜ_{_{—}}_{steady} and return if needs be to the preceding step;
once Vbᵢₙᵢₜ_{_{—}}_{steady} is established, carry out a static simulation 105 by imposing Vbᵢₙᵢₜ on Vbᵢₙᵢₜ_{_{—}}_{steady}, then a simulation 106 comprising the two stages, the transient stage 107 and then the stage of the steady state 108.

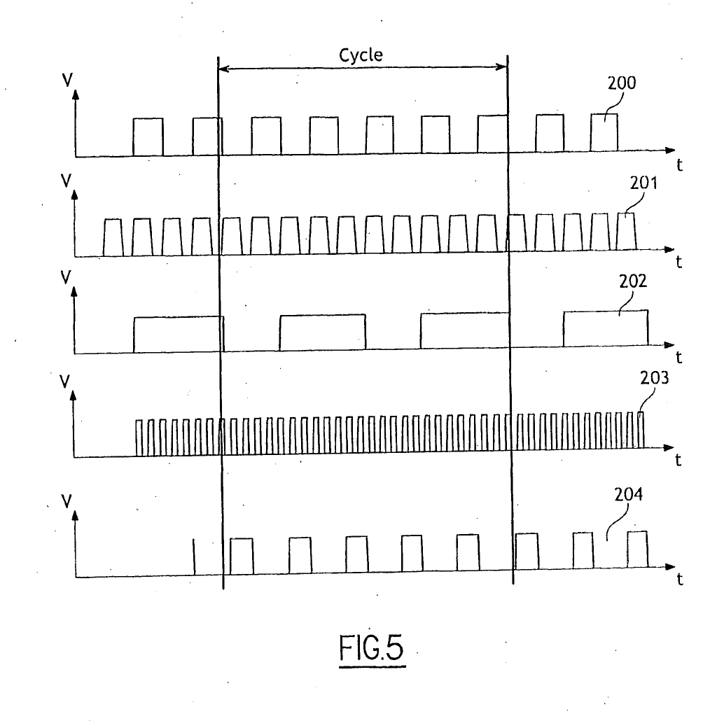

FIG. 4 illustrates the stages of the simulation of the circuit when the value Vbᵢₙᵢₜ_{_{—}}_{steady} has been established.

It is noted that the simulation of the transient stage 107 no longer exists, which reduces the time of the overall simulation of the circuit in the steady state.

The U.S. Pat. No. 6,442,735 document proposes an example of an application of such a general solution.

The method which is disclosed in it comprises different steps including those of:

1. creating a list of transistors of a circuit whose substrate is floating;

2. initialising the potentials Vbᵢₙᵢₜ;

3. implementing an initial static simulation 105;

4. implementing a simulation 106 of the circuit on a pre-set cycle-corresponding to a part of the transient stage 107;

5. evaluating the variation in charge ΔQb of the transistors between the start and end of this cycle;

6. if this variation is greater than a pre-set threshold value, returning to step (3) by adjusting the potential Vbᵢₙᵢₜ using a mathematical extrapolation;

7. otherwise, the value Vbᵢₙᵢₜ corresponds to the value Vbᵢₙᵢₜ_{_{—}}_{steady} and is taken as the initial value of the floating substrate in a last static simulation 105 then temporal 106 of the circuit.

In order to converge towards the floating substrate potential value Vbᵢₙᵢₜ_{_{—}}_{steady}, the following extrapolation calculation is implemented in step (6).

Firstly we know a mathematical law of the charge variation ΔQb of floating substrate according to the variation of the potential of this substrate:

ΔQbₙ=A(Exp(B(Vbₙ−Vbₙ₊₁))−1) (2)

where Vbₙ and Vbₙ₊₁ respectively correspond to the potential of floating substrate at the iteration n and n+1, and where A and B are coefficients.

It is to be noted that an iteration corresponds to the complete temporal simulation of the circuit, that meaning the succession of both simulations 105 and 106, the latter solely comprising the stage 107.

It is also noted that according to this equation, said charge variation ΔQb is correctly established to nil when the steady state is reached, or in other words, when Vbₙ₊₁ is equal to Vbₙ.

The coefficients A and B are evaluated through three first temporal simulations 106 in which the potentials Vb1, Vb2 and Vb3 are imposed at a pre-set initial value.

These simulations are implemented on a cycle corresponding to only a part of the transient stage 107.

At the end of said three simulations, we have three charge variations ΔQb1, ΔQb2 and ΔQb3, and the coefficients A and B are calculated by the respective equations:

$$\begin{matrix}A = \frac{( Δ {Qb}_{1} * Δ {Qb}_{3} - Δ {Qb}_{2} * Δ {Qb}_{2} )}{( 2 Δ {Qb}_{2} - Δ {Qb}_{1} - Δ {Qb}_{3} )} & ( 3 ) \\ B = \frac{Ln ( \frac{Δ {Qb}_{2} + A}{Δ {Qb}_{1} + A} )}{( {Vb}_{1} - {Vb}_{2} )} & ( 4 )\end{matrix}$$

the potential Vbn+1, which cancels out the equation (2) and which corresponds to the potential of initial floating substrate of the following iteration, is deduced from the expression (5):

$${Vb}_{n + 1} = {B}^{- 1} * Ln ( \frac{\begin{matrix}Δ {Qb}_{n} * Exp ( B * {Vb}_{n - 1} ) - \\ Δ {Qb}_{n - 1} * Exp ( B * {Vb}_{n} )\end{matrix}}{Δ {Qb}_{n} - Δ {Qb}_{n - 1}} ) \qquad ( 5 )$$

This method, efficient in terms of increased simulation speed, thus allows a relatively fast simulation in the steady state of circuits incorporating partially depleted SOI transistors.

All the same, such a method comprises a certain number of inconveniences notably when the size of the circuits to be simulated increases.

Indeed, in the presence of a circuit containing nodes, the simulator induces the Kirshov law on each said node.

Greater the number of nodes all the more time this resolution takes, as the number of equations and dependences increase.

Yet in the method of the applicant U.S. Pat. No. 6,442,735 such a resolution process is implemented at each iteration in the simulations 105 and 106 and, moreover, on the circuit incorporating all the connected transistors.

Thus, when the number of nodes is great, the method of the document U.S. Pat. No. 6,442,735, compared to a standard simulation, admittedly constitutes an advantageous solution to the problem of simulation in the steady state of a circuit.

But the simulation duration can remain lengthy and harmful to an efficient design of circuit in terms of productivity.

A purpose of the invention is to allow to overcome at least to a certain extent these inconveniences.

For this reason the invention proposes a method for simulating a response of an electronic circuit in a steady state, said circuit comprising components such as SOI type transistors, characterised in that it comprises the following steps:

(a) creating of a list of transistors;

(b) memorising signals at the nodes of each transistor in the list, when simulation excitation signals are applied to inputs of said circuit during an established time interval;

(c) for each transistor in the list, independently from the others, analysing a variation of, an electric property common to each of them when we apply to, at their nodes, said corresponding memorised signals, in relation with a pre-set criterion of this variation;

(d) if the criterion is not respected:
i. modify once an initial electric environment of each said transistor, so as to converge to said criterion;
ii. and return to step (c);

(e) applying once again said simulation excitation signals of step (b) at said inputs of the circuit during said time interval, the circuit containing said transistors whose said initial electric environment has been modified, and checking for each said transistor that said criterion is respected.

Thus, in the invention we advantageously handle the steady state of each transistor separately and we check that these individual steady states correspond to those of each corresponding transistor in the circuit.

Some preferred aspects, but non restrictive, of this method are the following:
in step (b), we firstly implement a static analysis;
in step (a), we create a list of SOT transistors possessing a floating substrate;
in steps (b) and (e), the nodes corresponding to the floating substrates are free, and in steps (c) and (d), we initialise their respective potential via a distinct electric source of simulation;
the excitation signals applied in step (b) are periodic temporal signals;
step (b) preliminarily comprises a step of determining said time interval;
said determining step consists in evaluating a property common to said excitation signals in step (b);
said common property is the period;
said establishing step, in step (b), consists in evaluating the lowest multiple period of the periods of said excitation signals;
in step (b), we memorise the signals of at least three nodes of each transistor;
step (c) comprises the disconnection of the nodes of the transistors of said list of said circuit;
in step (c), said application of the signals is implemented by connecting distinct electric sources of simulation to said nodes of each said independent transistor;
each electric source reproduces the memorised signal corresponding to the node to which it is connected;
in steps (b) and (c), said nodes of each transistor are:
   the gate;
   the drain;
   the source;
in steps (d) and (e), we respectively establish and check if said criterion is respected by comparing the variation of said electric property to a pre-set threshold value during said time interval;
said property is the charge of the floating substrate;
we implement a new series of steps (b) to (e) as long as, at the end of step (e), said criterion is not respected;
in step (b) of the new series, said initial electric environment of each transistor corresponds to that of the last modification carried out in step (d) of the preceding series;
in step (d), we modify said initial electric environment of the transistors by modifying their initial potential of floating substrate;
said memorising in step (b) consists in storing data representative of said signals in a file;
in step (c), said data stored in the file is read to apply said corresponding signals.

Other aspects, purposes and advantages of the invention will become clearer upon reading the following detailed description of a preferred embodiment of the latter, given by way of non restrictive example and made in reference to the annexed drawings, in which:

FIG. 1A illustrates the evolution over a large time scale of the potential of floating substrate, of a P type partially depleted SOI transistor of a CMOS-SOI invert er;

FIG. 1B illustrates an exploded view of FIG. 1A at the beginning of simulation during a transient stage;

FIG. 1C illustrates an exploded view of FIG. 1A at the end of simulation of simulation in the steady state;

FIG. 2 diagrammatically represents the CMOS-SOI inverter used in the simulation whose results are illustrated in FIGS. 1A to 1C;

FIG. 3 basically illustrates three stages of a simulation in the steady state of a circuit;

FIG. 4 illustrates a simulation in the steady state of a circuit when the potentials of floating substrates are initialised to Vbᵢₙᵢₜ_{_{—}}_{steady};

FIG. 5 illustrates an example of determining a cycle in the simulation of a circuit;

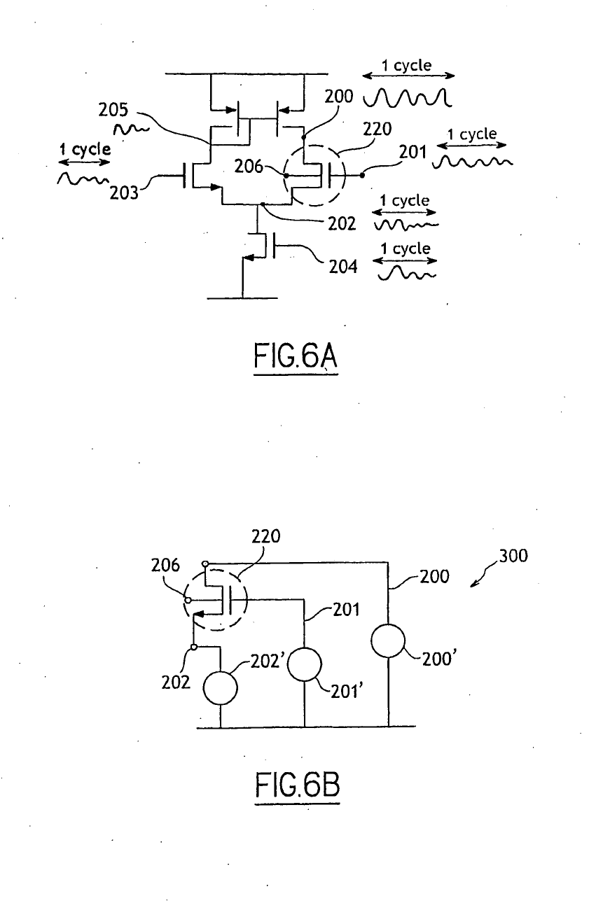

FIGS. 6A and 6B illustrate a disconnecting of a transistor of a circuit according to the method with the view of independently analysing it;

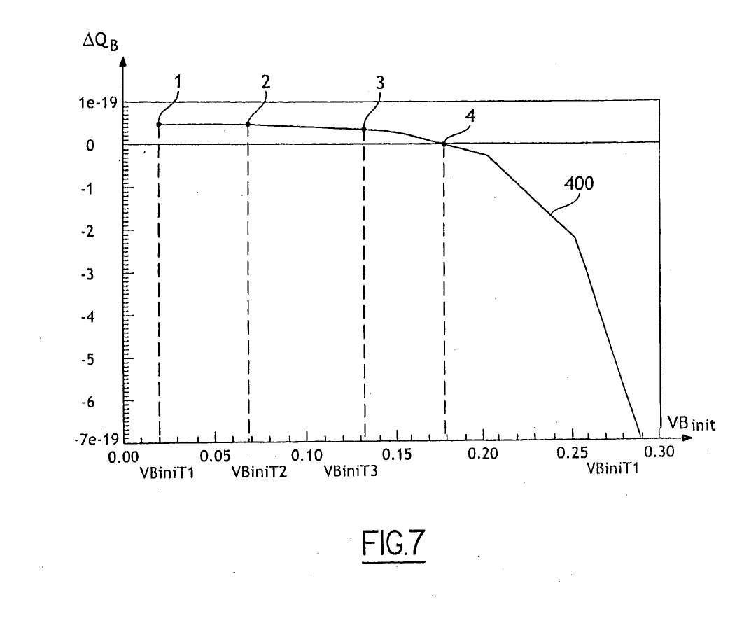

FIG. 7 illustrates a charge variation of floating substrate of a N type partially depleted SOI transistor used in a CMOS-SOI inverter.

The invention itself also relies on the principle of the charge conservation of floating substrate of a partially depleted SOI transistor when the latter is in a steady state and the method that it proposes is the following.

A first step consists in examining transistors which form a circuit to be simulated.

More precisely, a registering of the SOI transistors whose substrate is floating is implemented and a list of them is compiled.

A second step consists in determining the minimal cycle on which the eventual simulations will be carried out.

This determining step consists in evaluating for example the lowest multiple period of the periods of all the inputs of said circuit.

An illustration is given in FIG. 5 where five signals corresponding to 5 inputs of a circuit are represented.

In this example, all the signals are periodic, but the periods are different.

And, the lowest multiple period of the inputs of the circuit is that of signal 203.

It will thus serve to define the minimal cycle on which the next simulations will be based.

More generally speaking, for input signals of periods T, a minimal cycle is established by the following equation:

cycle=LCM(T₁)

where LCM designates the lowest common multiple.

A third step then consists in implementing a first temporal simulation on said cycle, said simulation of course comprising an initialising static simulation 105.

At the end of the cycle or even of the simulation, the cycle is thus, a priori, in transient stage 107, the steady state not having had the time to settle.

During the static simulation, we leave the potential of the floating substrates of the transistors noted in said list free, that meaning that these potentials are not imposed by any means during this simulation.

During the temporal simulation, the potentials of the gates, drains and sources of all the transistors are recorded.

We thus have a memory of the evolution through time of said aforementioned potentials.

A fourth step then consists in creating means which will allow to reproduce in subsequent electric simulations the thus memorised signals.

We note that all the internal signals of the circuit being periodic, it is easy, if it proves necessary, to rebuild them over a time period longer than a cycle.

Regarding said means of reproducing signals, we can use voltage sources that can be parameterised.

These sources can generate a signal of which, for example, each point is read in a file.

This file is constituted during said third step, that meaning in the memorising step of the potentials at the nodes of said circuit.

The information contained in the file can also provide details on the properties of the signal: the period, the high and low levels and any other parameter that those skilled in the art possess in order to establish the form of an electric signal.

Those skilled in the art thus understand that numerous variations can be envisaged and that the above described example is in no way restrictive.

In a fifth step, each registered transistor is simulated separately, by applying on its gate, drain and source, the three signals memorised at its nodes in step 3, during the simulation of the complete circuit, and via means created in step 4.

Thus, in this fifth step, we disconnect each transistor from the rest of said circuit in order to connect the means for reproducing the appropriate signals.

This type of manipulation is illustrated by way of non restrictive example in FIGS. 6A and 6B.

In FIG. 6A, the signals 200, 201 and 202, at the terminals of transistor 220, were recorded on a cycle during step 3.

In FIG. 6B, three periodic voltage sources 201′, 202′ and 203′ are created in order to reproduce exact copies of said three signals 200 to 202.

Furthermore, we disconnect the transistor 220 so as to isolate it from the rest of said circuit and we connect at its terminals said three periodic voltage sources designed for this purpose.

The node 206 corresponds to the floating substrate of the transistor 220.

Its potential is initialised at the beginning of simulation by means of a non-represented voltage source.

A simulation of sub-circuit 300 thus constituted can then be implemented.

It is noted that a preferred embodiment of the invention consists in carrying out a single simulation for all the isolated transistors.

In this case, all of the isolated transistors as well as the periodic voltage sources to which they are connected are brought together in a single simulation (possibly in a single file).

The implementing of a simulation thus allows to obtain in one go results for all the transistors.

The purpose of this temporal simulation is to find, or at least to approach as quickly as possible, the steady state value of the potential of floating substrate Vbᵢₙᵢₜ_{_{—}}_{steady} of each transistor.

During the first iteration, a first value of the initial voltage Vbᵢₙᵢₜ is chosen and a temporal simulation of the transistors newly connected to said means for memorising is implemented.

During the simulation, the charge of floating substrate of each transistor evolves and reaches a final value which is compared to the initial value of the beginning of the simulation.

If the charge variation, on a cycle, of floating substrate of one of the transistors, is greater than a pre-set threshold value, its potential Vbᵢₙᵢₜ is modified and is used as the initial value for a new iteration.

Of course, such a process relates to all the transistors and said modifications are all implemented independently one from the other.

This process is repeated as long as, during the cycle, said charge variation of each transistor exceeds said set threshold value.

By way of non restrictive example, FIG. 7 illustrates this process.

Four successive iterations are respectively represented by points 1, 2, 3 and 4 to which correspond, for each one, a potential Vbᵢₙᵢₜ and a charge variation ΔQb (ex. (Vbᵢₙᵢₜ₁; ΔQb₁), etc.) (see curve 400 in FIG. 7).

Remembering that an iteration designates a static simulation 105 followed by a temporal simulation 106 on the chosen cycle.

At the end of the first iteration, ΔQb₁ is greater than the pre-set threshold.

The method thus modifies the value of potential Vbᵢₙᵢₜ₁ which becomes Vbᵢₙᵢₜ₂.

The second iteration then starts and, once ended, a new comparison is implemented for ΔQb₂.

Four iterations, therefore four modifications of Vbᵢₙᵢₜ will be necessary in this example in order to reach the steady state characterised by a nil ΔQb variation.

This situation is diagrammatically represented by point 4, intersection of curve 400 with the nil ordinate axis.

The convergence of the potential of floating substrate towards the value Vbᵢₙᵢₜ_{_{—}}_{steady} can be implemented by means of different solutions.

Notably, in the above mentioned case, simply incrementing Vbᵢₙᵢₜ allows to successfully achieve a result.

Of course, an increment step must be defined that the user establishes himself or leaves the method implement an optimal setting of the latter.

In any case, it is preferable that this step has a value so that there is a guarantee of convergence and that an ideal compromise is respected between the convergence speed and the precision of the result.

Another solution consists in implementing a dichotomy process with as discriminator the sign of the charge variation ΔQb during the iteration and as convergence criterion the desired precision on ΔQb.

We can for example start by performing three iterations.

In the first (point 1), the potential Vbᵢₙᵢₜ₁ has the smallest possible value; in the second, on the contrary, the potential Vbᵢₙᵢₜ₁ has the biggest possible value (point 2); and in the third Vbᵢₙᵢₜ₃ has a median value of the preceding two.

A first analysis of ΔQb₃ can then be carried out at the end of said third iteration and, according to its sign, increase or decrease Vbᵢₙᵢₜ₄.

Other solutions are furthermore envisaged such as notably the use of self-adapting algorithms.

It is evident that those skilled in the art will understand the numerous possible adaptations in this regard among others.

The fifth step ends when the charge variation during the cycle of the last iteration is lower than the pre-set threshold.

A sixth step then consists in once again simulating the complete circuit including the connected transistors.

Here, contrary to the simulation of step 3, the potentials of floating substrate are initialised to their respective value Vbᵢₙᵢₜ_{_{—}}_{steady} during the static 105 and temporal 106 simulations, so that, as intended, the transient stage 107 only lasts for a short instance and that the steady state stage 108 is quickly reached.

This time we check whether the transient stage 107 is entirely simulated or not, this meaning that tₛₜₐₜ is less or equal to t₁ or that the charge variation of each transistor is always less than the set threshold.

As regards the steady state stage 108 that follows, it is simulated over any duration chosen by the user, all of the potentials Vbᵢₙᵢₜ_{_{—}}_{steady} can be reused at will.

An alternative of the aforementioned method and which allows to reach a greater precision for the estimation of potentials Vbᵢₙᵢₜ_{_{—}}_{steady} is now proposed.

This alternative is based on the observation that the signals memorised in step (3) are slightly biased and that all the following steps of the method are based on the repetitive use of these biased signals.

One reason for such a bias comes from the fact that the memorisation step of the signals takes place during the transient stage of the circuit.

These signals therefore did not have the time to evolve towards a steady form which corresponds to that of the equilibrium state, also known as steady state of the circuit.

In particular, the voltage levels and the rise and fall times of the signals on some nodes (for example node 200) substantially differ between the transient stage and the steady stage.

In order to correct this deviation, which affects the estimation of voltages Vbᵢₙᵢₜ_{_{—}}_{steady}, we once again implement the method after step (5) or step (6).

More precisely, the method is taken up at step (3) of simulation of the circuit.

This time we initialise the potentials of floating substrate to the values Vbᵢₙᵢₜ_{_{—}}_{steady} which have just been established.

In this way, during the transient stage of the simulation, the circuit is already very close to the steady state and the memorised signals resemble to a greater extent to their final form.

The bias is thus diminished and the estimation of the potentials of floating substrate Vbᵢₙᵢₜ_{_{—}}_{steady} of each transistor is improved during the subsequent steps of the method.

Of course, the invention is in no way restricted to the form of the above detailed embodiment represented in the drawings.

It is obvious, in particular, that the principle of the charge variation, which cancels out during a cycle in the steady state can be probed in different ways.

For example, in the above text, the method directly analyses the variation ΔQb, but other variables can be chosen.

Indeed, it is sufficient that the latter allow, directly or indirectly, to deduce if the steady state has been reached.

Such is the case notably of the potential of substrate Vb itself which becomes stable in the steady state.

1-21. (canceled)

22. A method for simulating a response of an electronic circuit in a steady state, said circuit having inputs and comprising components such as SOI type transistors, the method comprising the following steps:
(a) creating of a list of transistors;
(b) storing signals present at the nodes of each transistor in the list when simulation excitation signals are applied to inputs of said circuit during a given time interval;
(c) for each transistor in the list, independently from the others, analyzing a variation of an electric property common to each of them when said corresponding stored signals are applied to the nodes thereof, in relation with the meeting of a predetermined criterion of this variation;
(d) if the criterion is not met:
i. modify once an initial electric environment of each said transistor, so as to converge to said criterion;
ii. and return to step (c);
(e) applying once again said simulation excitation signals of step (b) at said inputs of the circuit during said time interval, the circuit containing said transistors whose said initial electric environment has been modified, and checking for each said transistor that said criterion is respected.

23. A method as set forth in claim 22, wherein in step (b) comprises a preliminary static analysis.

24. A method as set forth in claim 22, wherein step (a) comprises creating a list of SOI transistors having a floating substrate.

25. A method as set forth in claim 24, wherein in steps (b) and (e), the nodes corresponding to the floating substrates are free, and wherein in steps (c) and (d), said nodes are initialized to a respective potential via a distinct electric source of simulation.

26. A method as set forth in claim 22, wherein the excitation signals applied in step (b) are periodic time signals.

27. A method as set forth in any of the previous claims, wherein step (b) comprises a preliminary determination of said time interval.

28. A method as set forth in claim 27, wherein said time interval determination in step (b) comprises evaluating a property common to said excitation signals in step (b).

29. A method as set forth in claim 28, wherein said common property is the signal period.

30. A method as set forth in claim 27, wherein said time interval determination in step (b) comprises evaluating the lowest multiple period of the periods of said excitation signals.

31. A method as set forth in claim 22, wherein step (b) comprises storing the signals present at least three nodes of each transistor.

32. A method as set forth in claim 22, wherein step (c) comprises disconnecting the nodes of the transistors in said list of said circuit.

33. A method as set forth in claim 22, wherein, said application the corresponding stored signals in step (c) is implemented by connecting distinct electrical sources of simulation to said nodes of each independently analyzed transistor.

34. A method as set forth in claim 33, wherein each electrical source reproduces the stored signal corresponding to the node to which it is connected.

35. A method as set forth in claim 22, wherein said nodes of each transistor are a gate, a drain and a source.

36. A method as set forth in claim 35, wherein step (c) comprises comparing the variation of said electric property with a predetermined threshold value during said time interval.

37. A method as set forth in claim 36 taken in combination with claim 3, wherein said property is the charge of the floating substrate.

38. A method as set forth in claim 22, wherein steps (b) to (e) are repeated as long as said criterion is not met at the end of step (e).

39. A method as set forth in claim 38, wherein for each repeated step (b), said initial electric environment of each transistor corresponds to the modification performed in the immediately preceding step (d).

40. A method as set forth in claim 24, wherein the modification of the electrical environment of the transistors in step (d) comprises modifying their initial floating substrate potential.

41. A method as set forth in claim 22, wherein said storing of signals present at the nodes of each transistor in step (b) comprises storing data representative of said signals in a file.

42. A method as set forth in claim 41, wherein said data stored in said file are read in order to apply said corresponding signals.
